(19) United States
(12) Patent Application Publication
(10) Pub. No.: US 2005/0077437 A1
(43) Pub. Date: Apr. 14, 2005

(54) Removably mountable wire, rope, cable and hose retention device

(76) Inventor: Don F. Widlacki, Newport News, VA (US)

Correspondence Address: Duncan G. Byers;Suite 1200, 500 East Main Street, Norfolk, VA, 23510, US

(21) Appl. No.: 10/960,736

(22) Filed: Oct. 7, 2004

Related U.S. Application Data
(60) Provisional application No. 60/510,533, filed on Oct. 14, 2003.

(51) Int. Cl. F16L 3/08

(52) U.S. Cl. 248/70; 248/74.1

(57) ABSTRACT

A device for stabilizing and protecting wires, cables, ropes, hoses and/or other similar objects, materials, devices or structures on, over, or around exposed non-linear surfaces includes one rigid half slidably insertable into a second rigid receiving half over or around a non-linear exposed surface and having an interior space defined by the two structures that accommodates, stabilizes and protects one or more wires, cables, ropes, hoses and/or other similar objects, materials, devices or structures.

### BACKGROUND OF THE INVENTION

The present invention relates in general to a surface-mounted retention system and deals more particularly with a device for routing, stabilizing and protecting wires, cables, ropes, hoses and/or other similar objects, materials, devices or structures across and around non-linear discontinuities on surface areas over which the wires, cables, ropes, hoses and/or other similar objects, materials, devices or structures must run.

When wires, cables, ropes, hoses and/or other similar objects, materials, devices or structures are placed across a surface, there must be provided means for affixing them to the surface, either temporarily or permanently. Such fittings are easily designed and affixed on linear or planar surfaces. Where there is a non-linearity in the surface, such as at a corner of a structure, the edge of a table, or over the gunwale or transom of a boat, the wires, cables, ropes, hoses and/or other similar objects, materials, devices or structures must be draped over the edge or corner, and are then affixed, if at all, on either side of the edge or corner through the use of flat surface mounting devices. However, draping the restrained object or objects across a surface with a discontinuity, such the edge of a boat at the gunwale, can allow friction damage to occur to the draped object or objects, as well as allowing an undesirable freedom of movement. Such movement, either across the edge or back and forth along the edge of the structure can cause damage to both the draped objects as well as the surface over which the wires, cables, ropes, hoses and/or other similar objects, materials, devices or structures are draped. In the alternative, affixing the wire, cable or rope on either side of the non-linearity, corner or edge through the use of flat surface mounting brackets can cause stress on the wires, cables, ropes, hoses and/or other similar objects, materials, devices or structures, and may be undesirable for more temporary placement. In either situation, the wire, cable or rope is left exposed to the elements and is unprotected from external damage; such damage may be exacerbated by the corner or edge underneath the wires, cables, ropes, hoses and/or other similar objects, materials, devices or structures.

These problems are particularly troublesome when such objects must be run over or around corners on boats, ships and in other situations where there is a great deal of exposure to physical damage as well as exposure to the elements. There is limited space available under such conditions, so the objects are exposed to an unnecessary amount of physical damage. In addition, physical motion of the boat or other vehicle will cause rubbing between the corner or edge that the wires, cables, ropes, hoses and/or other similar objects, materials, devices or structures is draped or secured over and the draped objects themselves, causing rapid wear and the threat of failure of the wires, cables, ropes, hoses and/or other similar objects, materials, devices or structures. Further, such draped objects create a clutter hazard in such confined spaces as those found on boats, other vehicles, or in other areas where space is limited. Finally, the existing means of securing such objects require semi-permanent or permanent means of attachment that can damage or breach the structure that the draped object is affixed to; adhesives are unstable and may damage paint and other similar coatings, both on the surface and on the draped object, and screws, bolts, nails, staples and the like cause structural damage and create areas for rot and rust to develop, particularly in those areas exposed to the elements such as in marine applications.

A simple and inexpensive bracket which secures, protects and affixes, either temporarily, semi-permanently, or permanently, without causing wear or damage to either the surface or restrained objects such as wires, cables, ropes, hoses and/or other similar objects, materials, devices or structures and the like across, over, and around corners such as the edge of tables or the gunwale or transom of a boat and without requiring the use of adhesives, screws, bolts, nails, staples or similar means of attachment and the like is greatly in need. Accordingly, it is the general aim of the present invention to provide an improved device for securing and protecting, either temporarily or permanently, wires, cables, ropes, hoses and/or other similar objects, materials, devices or structures across, over or around non-linear surface discontinuities such as the edge of a table or gunwale or transom of a boat.

### SUMMARY OF THE PRESENT INVENTION

The present invention provides a device for securing wires, cables, ropes, hoses and/or other similar objects, materials, devices or structures across, over, or around non-linear surface discontinuities such as the corners or edges of structures temporarily, semi-temporarily, or permanently. The device comprises two sections, each generally “L” shaped, although other shapes may be suitable, depending upon the surface, one slideably insertable into the other, and secured to each other through screws, bolts, or other means of pulling the two halves of the device together over the non-linearity, edge or corner in a general “U” shape. The cross-sectional shape of the two halves may be any shape that prevents the first half, inserted into the second half, from moving in a direction perpendicular to the common axis by which the two halves are slidably joined. Such a cross-sectional shape may be circular, triangular, or any similar shape. Experimental use has shown that the preferred cross-sectional shape is in the general shape of an “+”, as viewed down the insertable axis, which will be readily apparent to one skilled in the art from the figures and description below.

The inner surface of the two joined halves of the current invention faces onto the non-linearity, edge, or corner of the surface to which it is to be attached. The inner surface of the present invention comprises a hollowed-out area formed by the junction of the two halves, creating a channel through which the restrained objects, such as wires, cables, ropes, hoses and/or other similar objects, materials, devices or structures may pass and be secured. When compressed against each other, the two halves of the device create a friction fitting against the surface that creates a temporary, semi-permanent, or permanent channel to restrain and protect the restrained objects that pass through the device. The device may be constructed in various sizes and shapes to accommodate various restrained objects, as well as various sizes and shapes of edges or surfaces that the device may be assembled over and around, such as the gunwale or transom of a boat, the edge of a table, or other similar surface. The present invention may be constructed of a variety of materials for a variety of applications, from light household applications to heavy industrial and marine applications. Suitable construction materials for the present invention include woods, metals, plastics, rubber, and the like. It will be obvious to one skilled in the art that the present invention may function as intended in a multiplicity of sizes and shapes, constructed from a variety of rigid or semi-rigid materials, over a multiplicity of surfaces and in a multiplicity of applications without departing from the spirit and the scope of the present invention.

### BRIEF DESCRIPTION OF THE DRAWINGS

FIG. 1 is a bottom elevation view of the separated device halves of the present invention.

FIG. 2 is a bottom elevation view of both device halves of the present invention slidably joined together.

FIG. 3 is a front three-quarters elevation view of the slidably insertable first device half of the present invention.

FIG. 4 is a rear three-quarters elevation view of the slidably insertable first device half of the present invention.

FIG. 5 is a front one-third view of the receiving second device half of the present invention.

FIG. 6 is a side three-quarters view of the receiving second device half of the present invention.

FIG. 7 is a diagrammatic view of the present invention comprising a plurality of retaining channels.

### DESCRIPTION OF A PREFERRED EMBODIMENT

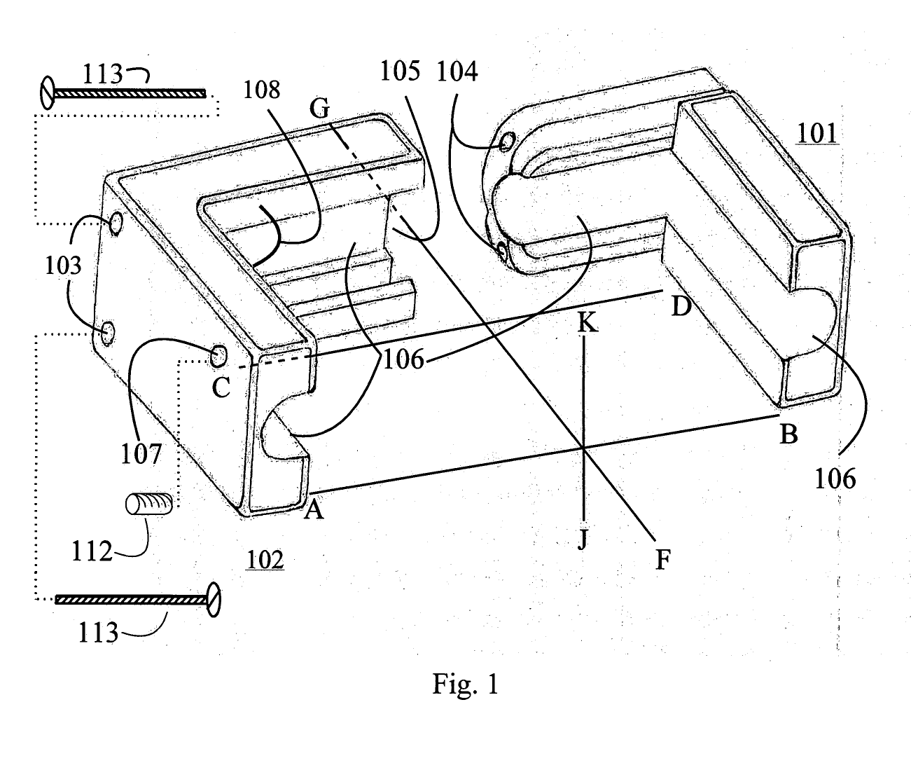

Referring now to the embodiment of the invention illustrated in FIG. 1, the first device half 101 slidably inserts into the shaped slot 105 of the second device half 102. Retaining screws 113 insert through holes 103 in device half 102 and thence into corresponding recessed threaded holes 104 in device half 101. Upon tightening the said screws 113 the two device halves 101 and 102 are pulled tightly together over and around the edge or non-linear surface. The two device halves 101 and 102 each further comprise a hollowed-out channel area or areas 106 to allow one or more restrained objects such as wires, cables, ropes, hoses and/or other similar objects, materials, devices or structures to pass under the two halves 101 and 102 of the present invention while the device halves 101 and 102 are assembled over a surface, creating a compression fit against said surface. Said channel area or areas 106 may be any recessed shape, but preferentially are generally semi-circular in cross-section, effectively restraining such objects as wires, cables, ropes, hoses and/or other similar objects, materials, devices or structures that are generally circular in cross section without an edged or angular channel area surface to come into contact with the restrained objects, causing wear and tear on the restrained objects. The channel area or areas 106 may further comprise a multiplicity of separate or multiple channel through which the said restrained objects may be passed either singly or in bundles or groups in order to accommodate a multiplicity of said restrained objects while keeping them neat and organized, or to keep different types of restrained objects isolated, such as isolating wires of different polarities or providing separate channels for cables and wires, thereby preventing one restrained object from damaging or interfering with another, electrically, physically or otherwise. The angle 108 of device half 102 may be any angle between 0° and 180° which will still allow the device to be clamped over a surface, but should be slightly less than 90°, and preferentially between 80° and 90°, and more particularly an angle of less than 1°, allowing the two halves 101 and 102 to ‘lock’ onto the surface the device is clamped over; the angle 108 being slightly less than 90° allows the assembled device to have a distance A-B that is slightly less than the distance C-D, creating greater pressure on the surface over which the device is assembled along the axis C-D than along the axis A-B, resulting in a secure friction lock between the two device halves 101 and 102 as the recessed slot area 105 of half 102 presses downward along axis G-F in the direction from G to F, onto the slidably insertable portion 109 of half 101, further securing the friction lock onto the surface over which the device is assembled. Although the angle 108 may be on either device half 101 or half 102, it is preferentially located on half 102. The friction lock between the surface and the device is further reinforced by a screw 112, which is threaded into screw hole 107 in device half 102 and tightened against the mounting surface over which the device is assembled. The screw 112 provides tension against the surface over which the invention is fastened or assembled, keeping the device securely fastened and immobile, and further restricts motion of the assembled device along the vertical axis F-G. In addition to preventing motion along the axis F-G, tightening the screw 112 also results in additional downward force upon the slidably insertable portion 109 from the recessed slot area 105, reinforcing the friction lock between the two halves of the assembled device and helping to secure and stabilize the entire assembled device.

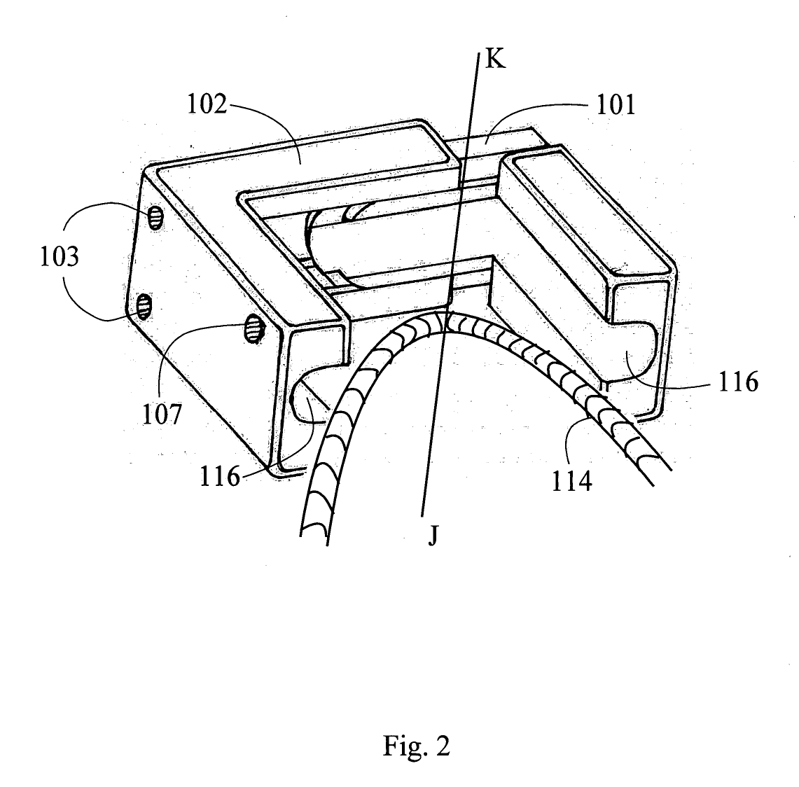

FIG. 2 is a bottom elevation view of the present invention showing the assembled device with both device halves 101 and 102 slidably inserted together. Screws 113 are inserted through the holes 103 in half 102 and then tightened in the threaded holes 104 (not visible in this Figure) in device half 101, pulling the two device halves 101 and 102 together over and around the non-linearity, edge, or corner of the surface. The corner or edge over which the device is clamped is oriented along the axis indicated by the line A-B, with the single or plurality of objects to be restrained 114 positioned over or around the non-linearity, edge, or corner of the surface and under the assembled device through the channel area or areas 106. The device may further comprise a soft or malleable material such as rubber or other similar, shock and friction-reducing material affixed to the interior surface 116 and/or the channel area or areas 106 such that the non-linearity, edge, or corner of the surface as well as the restrained object or objects 114 are protected from vibration, friction, and/or pressure damage.

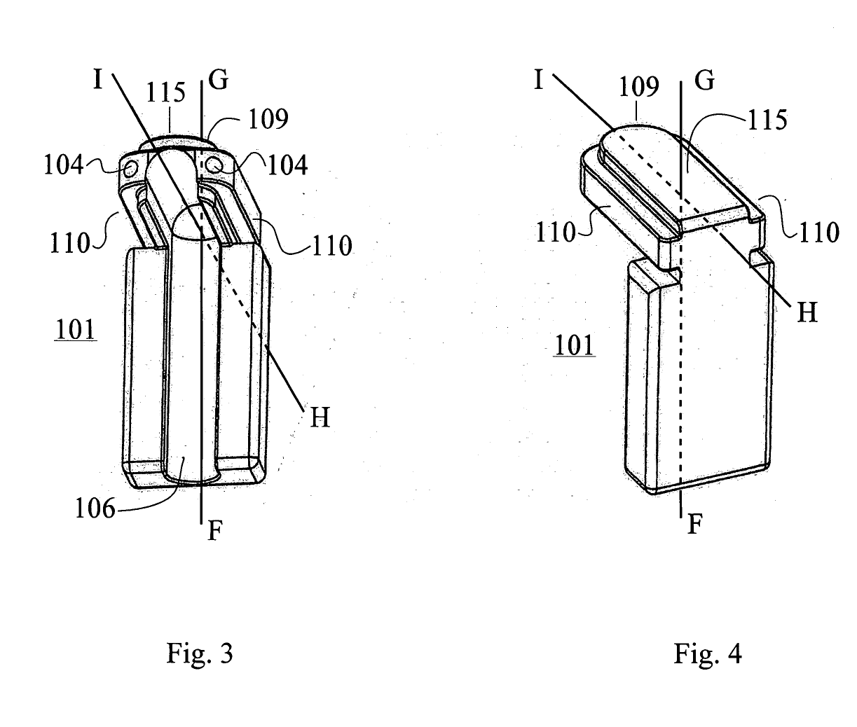

FIGS. 3 and 4 are views showing the structural details of device half 101. In particular, FIGS. 3 and 4 show the slidably insertable portion 109 of device half 101. The slidably insertable portion 109 comprises a central portion 115 and a lip 110 extending from the central portion 115 of the device half 101 and running the length of the central portion 115 along the axis H-I. The lip 110 restricts unwanted motion along the axis F-G of the assembled device halves 101 and 102, and assists in creating the secure friction fitting between the halves 101 and 102. Lip 110 further comprises structural support for the threaded holes 104 and the channel area or areas 106. The shape of the slidably insertable portion 109 generally provides structural support as well as being advantageous for allowing the two device halves 101 and 102 to create a strong friction lock when the device is assmembled.

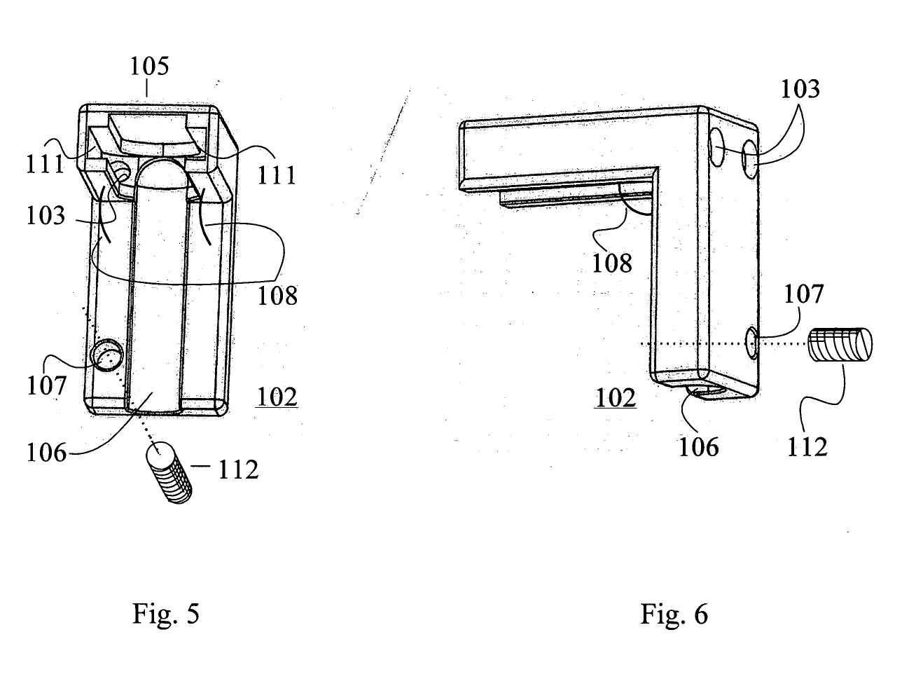

FIGS. 5 and 6 are views showing the structural details of device half 102 comprising the screw holes 103, recessed slot area 105, channel area 106, set screw hole 107, angle 108, recesses 111, and set screw 112. In particular, FIG. 5 shows the structural details of the interior surface of device half 102 that faces onto the non-linearity, edge, or corner of the surface over which the device is assembled. The shaped slot 105 accommodates the corresponding shape of device half 101 with the recesses 111 accommodating the corresponding lip 110 on device half 101 as seen in FIGS. 3 and 4. FIGS. 5 and 6 also reveal the screw holes 103 and the set screw hole 107 which accommodates the set screw 112.

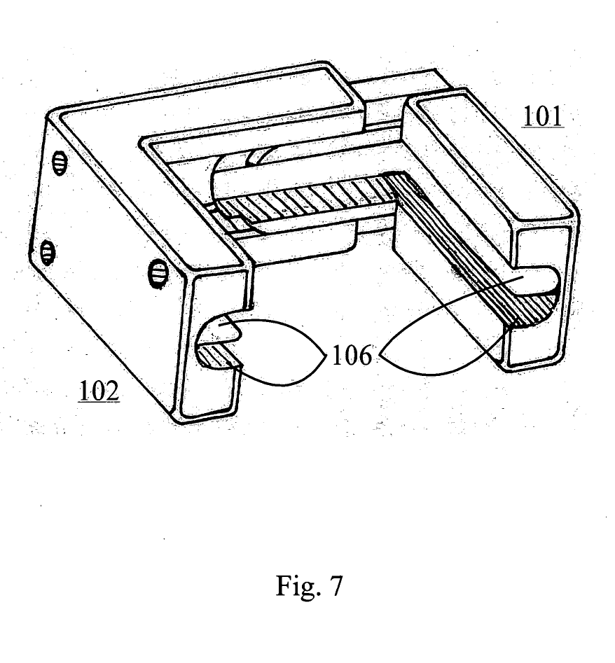

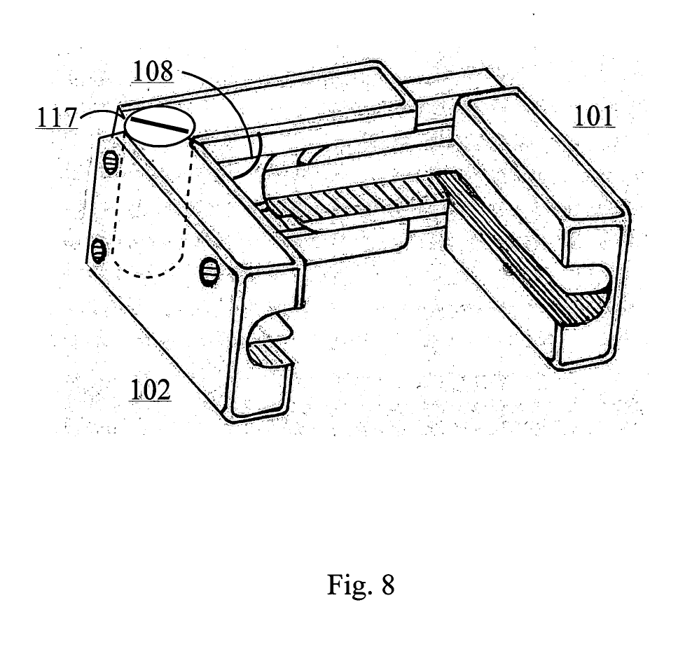

FIG. 7 is a view of the assembled device with a plurality of channels areas 106.

This invention has been described in connection with a preferred embodiment thereof, and it should be clear to one skilled in the art that modifications and changes therein may be made by one skilled in the art without departing from the spirit and scope of the invention. The details of the present invention as described are illustrative only, and do not limit the scope of the present invention as claimed below.

1. A device for restraining objects, materials, devices, or structures against a non-linear surface, comprising:
a first device half having an interior and an exterior surface, a horizontal member and a vertical member wherein the horizontal member is slidably insertable into a second device half having an interior surface, an exterior surface, a horizontal member and a vertical member wherein the interior surface of the horizontal member includes a recessed slot area for receiving the slidably insertable horizontal member of said first device half;
one or more channels along the length of the interior surface of the horizontal and vertical members of said first device half;
one or more channels along the length of the interior surface of the vertical member of said second device half wherein said one or more channels align with the said one or more channels along the interior surface of the horizontal member of said first device half when said first device half is inserted into said second device half;
an angle between 0 and 180 degrees at the junctions of said horizontal and vertical members of said first and second device halves; and
a fastening means such that said first device half remains affixed as inserted into said second device half and the device as a whole remains affixed to said nonlinear surface.

2. The device of claim 1 further comprising one or more restraining screws located in one or both of said device halves such that said one or more restraining screws may be tightened against said non-linear surface.

3. The device of claim 1 wherein said slidably insertable horizontal member of said first rigid half comprises a central portion and a lip extending from the central portion along the perimeter of the central portion.

4. The device of claim 1 wherein said one or more channels of said first and second device halves are semi-circular in shape.

5. The device of claim 1 wherein said fastening means comprises one or more bolts, screws, or other such fastening devices and corresponding one or more screw or bolt holes wherein said one or more screw or bolt holes may be threaded.

6. The device of claim 1 wherein said fastening means is a friction lock between said first and second device halves.

7. The device of claim 1 wherein said angle between the said horizontal member and the vertical member of said first and second device halves is between 0° and 90° such that when said first device half and said second device half are insertably joined together, the horizontal distance between the interior edge of the vertical member of said first device half farthest from said first device half horizontal member and the interior edge of the vertical member of the said second device half farthest from said second device half horizontal member is less than the distance between the interior junction of the vertical and horizontal member of said first device half and the interior junction of the vertical and horizontal member of said second device half.

8. The device of claim 1 wherein said angle between the said horizontal member and the vertical member of said first and second device halves is between 80° and 90° such that when said first device half and said second device half are insertably joined together, the horizontal distance between the interior edge of the vertical member of said first device half farthest from said first device half horizontal member and the interior edge of the vertical member of the said second device half farthest from said second device half horizontal member is less than the distance between the interior junction of the vertical and horizontal member of said first device half and the interior junction of the vertical and horizontal member of said second device half.

9. The device of claim 1 further comprising moving means such that the horizontal member of said first or second device half may be moved relative to the vertical member of said first or second device half such that said angle between the horizontal and vertical members of said first or second device halves is adjustable.

10. The device of claim 9 wherein said means for moving the horizontal member relative to the vertical member further comprises means for locking said moving means such that the desired angle may be rigidly affixed.

11. The device of claim 1 wherein said fastening means comprises internal ridges or discontinuities in said first device half that correspond to recesses or discontinuities in said second device half such that said first device half becomes locked into place once it is slid into said second device half.

12. The device of claim 11 wherein said internal ridges or discontinuities in said first device half are attached by mechanical means to a release mechanism on the outside of said first device half.

13. The device of claim 1 further comprising an interior surface material wherein said interior surface material protects said restrained objects, materials, devices or structures are protected from vibration, friction, pressure and/or other structural or stress damage.

14. The device of claim 13 wherein said interior surface material is non-conductive.

15. The device of claim 13 wherein said interior surface material is a shock-reducing and friction-reducing material.

16. The device of claim 1 wherein said device comprises material that is non-conductive.

17. A device for restraining objects, materials, devices, or structures against a non-linear surface, comprising:
a first device half having an interior and an exterior surface, a horizontal member and a vertical member wherein the horizontal member is slidably insertable into a second device half having an interior surface, an exterior surface, a horizontal member and a vertical member wherein the interior surface of the horizontal member includes a recessed slot area for receiving the slidably insertable horizontal member of said first device half;
one or more channels along the length of the interior surface of the horizontal and vertical members of said first device half, said channels further comprising a material that reduces shock, friction, pressure, and is non-conductive;
one or more channels along the length of the interior surface of the vertical member of said second device half wherein said one or more channels align with the said one or more channels along the interior surface of the horizontal member of said first device half when said first device half is inserted into said second device half, said channels further comprising a material that reduces shock, friction, pressure, and is non-conductive;
an angle between 0 and 180 degrees at the junctions of said horizontal and vertical members of said first and second device halves; and
a fastening means such that said first device half remains affixed as inserted into said second device half and the device as a whole remains affixed to said nonlinear surface.

18. The device of claim 17 wherein said device comprises a semi-rigid material that reduces shock, friction, pressure, and is non-conductive.

19. The device of claim 17 further comprising one or more restraining screws located in one or both of said device halves such that said one or more restraining screws may be tightened against said non-linear surface.

20. The device of claim 17 wherein said fastening means comprises an internal locking mechanism wherein said internal locking mechanism is mechanically releasable.
